(19) United States
(12) Patent Application Publication
(10) Pub. No.: US 2026/0016788 A1
(43) Pub. Date: Jan. 15, 2026

(54) IMAGE FORMING APPARATUS

(71) Applicant: Norihisa KAKINUMA, Kanagawa (JP)

(72) Inventor: Norihisa KAKINUMA, Kanagawa (JP)

(21) Appl. No.: 19/251,816

(22) Filed: Jun. 27, 2025

(30) Foreign Application Priority Data
Jul. 12, 2024 (JP) 2024-112879

(51) Int. Cl. G03G 21/20; G03G 15/00; G03G 15/20

(52) U.S. Cl. CPC G03G 21/206; G03G 15/2017; G03G 15/5004; G03G 15/80

(57) ABSTRACT

An image forming apparatus includes a fixing device, a duct, an exhaust fan, and a switch. The duct is coupled to the fixing device to take in air and discharge the air outside the image forming apparatus in a discharge direction. The duct includes a first filter, a second filter, a first exhaust path, and a second exhaust path. The first filter collects first substances other than the ultrafine particles in the air. The second filter collects second substances including the ultrafine particles in the air. The first exhaust path includes the first filter and does not include the second filter. The second exhaust path includes the first filter and the second filter. The exhaust fan is at a downstream end in the discharge direction of the duct, to take in the air into the duct. The switch switches between the first exhaust path and the second exhaust path.

### CROSS-REFERENCE TO RELATED APPLICATION

This patent application is based on and claims priority pursuant to 35 U.S.C. § 119(a) to Japanese Patent Application No. 2024-112879, filed on Jul. 12, 2024, in the Japan Patent Office, the entire disclosure of which is hereby incorporated by reference herein.

### BACKGROUND

### Technical Field

The present disclosure relates to an image forming apparatus.

### Related Art

An electrophotographic image forming apparatus releases multiple types of chemical substances into the atmosphere during image formation. Examples of the chemical substances to be released include ozone generated during charging of the photoconductor, toner dust generated during developing and fixing operations. Countermeasures have been taken against the sources of these chemical substances to reduce the generation amounts or to prevent the generated chemical substances from being released to the atmosphere.

Recently, the generation of ultrafine particles (also referred to as UFP), which are different from ozone and toner dust, from the electrophotographic image forming apparatus has been considered problematic. The ultrafine particles are generated from substances constituting a fixing member or components of toner wax in a fixing device that fixes an unfixed image transferred onto a sheet by heat. It is known that a large amount of ultrafine particles are generated for a predetermined time from turning on a heater, and the amount of ultrafine particles decreases after the predetermined time. As a countermeasure, the electrophotographic image forming apparatus includes multiple filters to collect ultrafine particles while the large amount of ultrafine particles are generated, that is, when the power is turned on or when a fixing temperature is returned from a low temperature.

### SUMMARY

The present disclosure described herein provides an image forming apparatus including a fixing device, a duct, an exhaust fan, and a switch. The fixing device heats a toner image on a sheet and fixes the toner image onto the sheet. The duct is coupled to the fixing device to take in air and discharge the air outside the image forming apparatus in a discharge direction. The duct includes a first filter, a second filter, a first exhaust path, and a second exhaust path. The first filter collects first substances other than the ultrafine particles, generated from the fixing device during a fixing operation of the fixing device, in the air. The second filter collects second substances including the ultrafine particles in the air. The first exhaust path includes the first filter to pass the air from which the first substances are filtered and the second substances are not filtered. The second exhaust path includes the first filter and the second filter to pass the air from which both the first substances and the second substances are filtered. The exhaust fan is at a downstream end in the discharge direction of the duct, to take in the air into the duct. The switch switches between the first exhaust path and the second exhaust path.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic sectional view of an image forming apparatus to illustrate a configuration of the image forming apparatus;

FIGS. 2A and 2B are schematic diagrams illustrating a fixing device and a duct;

FIG. 3 is a schematic diagram illustrating an internal structure of a duct body;

FIG. 4 is a graph illustrating a relation between an amount of ultrafine particles generated and a number of sheets on which images are formed when the image forming apparatus of FIG. 1 continuously forms images under a certain image forming condition; and

FIGS. 5A and 5B are schematic diagrams of pleated filters.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

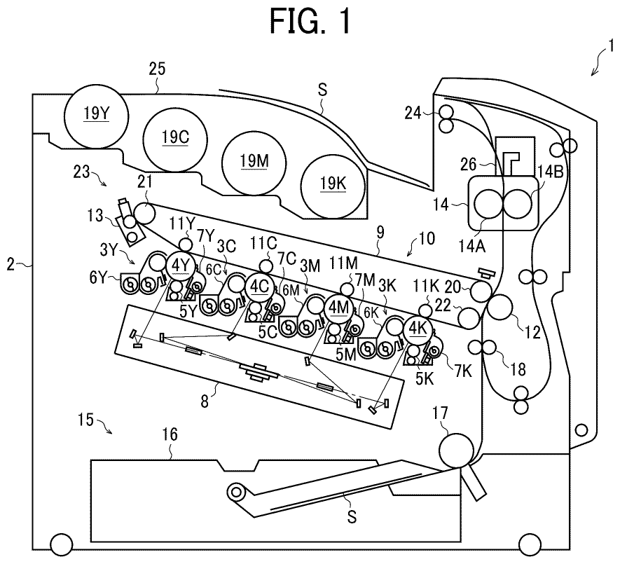

FIG. 1 illustrates a color copier as an example of an image forming apparatus.

The color copier 1 includes process cartridges 3Y, 3C, 3M, and 3K that form toner images of yellow (Y), cyan (C), magenta (M), and black (K), respectively. The process cartridges 3Y, 3C, 3M, and 3K are also collectively referred to as process cartridges 3 in the following description. The process cartridges 3 are disposed in a central portion of a body 2 of the color copier 1. The process cartridges 3Y, 3C, 3M, and 3K include photoconductor drums 4Y, 4C, 4M, and 4K as image bearers, respectively.

In FIG. 1, the photoconductor drums 4Y, 4C, 4M, and 4K rotate clockwise. Around the photoconductor drums 4Y, 4C, 4M, and 4K, charging devices 5Y, 5C, 5M, and 5K, developing devices 6Y, 6C, 6M, and 6K, and photoconductor cleaning devices 7Y, 7C, 7M, and 7K are disposed, respectively. The photoconductor drums 4Y, 4C, 4M, and 4K, the charging devices 5Y, 5C, 5M, and 5K, the developing devices 6Y, 6C, 6M, and 6K, and the photoconductor cleaning devices 7Y, 7C, 7M, and 7K are also collectively referred to as the photoconductor drums 4, the charging devices 5, the developing devices 6, and the photoconductor cleaning devices 7 in the following description. Below the process cartridges 3, an optical unit 8 is disposed to irradiate each photoconductor drum 4 with laser light.

Above the process cartridges 3, an intermediate transfer unit 10 is disposed. The intermediate transfer unit 10 includes, as a belt, an intermediate transfer belt 9 to which toner images formed by the process cartridges 3 are transferred. The intermediate transfer unit 10 includes multiple rollers to support the intermediate transfer belt 9, and the intermediate transfer belt 9 is stretched around a secondary-transfer backup roller 20, a tension roller 21, and an entrance roller 22. A drive motor drives and rotates the secondary-transfer backup roller 20, which drives and rotates the intermediate transfer belt 9 counterclockwise in FIG. 1.

The intermediate transfer belt 9 may be a single-layer belt or a multi-layer belt. The single-layer belt is preferably formed of polyvinylidene fluoride, polycarbonate, or polyimide. The multi-layer belt preferably includes a base layer formed of a material, such as fluoroplastic, polyvinylidene fluoride sheet, or polyimide resin, that is less stretchy, and the surface of the belt is covered with a smooth coat layer formed of, for example, fluorine-based resin.

At the positions on the inner peripheral side of the intermediate transfer belt 9 and opposite the photoconductor drums 4Y, 4M, 4C, and 4K, primary transfer rollers 11Y, 11C, 11M, and 11K (also collectively “primary transfer rollers 11”) are disposed. The primary transfer rollers 11 primarily transfer the respective toner images on the photoconductor drums 4 onto the intermediate transfer belt 9. A description is given of the formation of respective color toner images on the photoconductor drums 4 and the primary transfer of the toner images to the intermediate transfer belt 9.

Each photoconductor drum 4 rotates clockwise in FIG. 1. As a discharger irradiates a surface of the photoconductor drum 4 with light, a surface potential of the photoconductor drum 4 is initialized. After the initialization, the charging device 5 uniformly charges the surface of the photoconductor drum 4 to a given polarity (in the present embodiment, a negative polarity). The optical unit 8 emits laser beams onto the charged outer surface of the photoconductor drum 4, thus forming an electrostatic latent image of the corresponding color on the photoconductor drum 4.

The developing device 6 supplies toner of the corresponding color to the electrostatic latent image on the photoconductor drum 4, thereby developing the electrostatic latent image into a visible toner image. Meanwhile, the primary transfer roller 11 is applied with a primary transfer voltage opposite to the charging polarity of the toner image on the photoconductor drum 4. In the present embodiment, the primary transfer voltage has a plus (positive) polarity. As a result, transfer electrical fields are generated between the photoconductor drums 4 and the corresponding primary transfer rollers 11, and the respective color toner images on the photoconductor drums 4 are electrically transferred onto the intermediate transfer belt 9. The respective color toner images are superimposed on the intermediate transfer belt 9 to form a full-color toner image on the intermediate transfer belt 9. The intermediate transfer belt 9 functions as an image bearer that bears an image on its surface. After the respective color toner images are transferred onto the intermediate transfer belt 9, the photoconductor cleaning devices 7 remove the residual toner adhering to the surfaces of the photoconductor drums 4, and the photoconductor drums 4 are prepared for subsequent image formation.

Downstream from the primary transfer roller 11K in the traveling direction of the intermediate transfer belt 9 indicated by an arrow Y1, a secondary transfer roller 12 is disposed. The secondary transfer roller 12 secondarily transfers, onto a sheet S (a recording medium), the toner images having been primarily transferred onto the intermediate transfer belt 9. The secondary-transfer backup roller 20 contacts the secondary transfer roller 12 via the intermediate transfer belt 9 to form a secondary transfer nip. A predetermined transfer voltage is applied to the secondary transfer roller 12 to secondarily transfer the toner image formed on the intermediate transfer belt 9 to the sheet S. Further, upstream from the primary transfer roller 11Y in the traveling direction of the intermediate transfer belt 9, a belt cleaner 13 is disposed. The belt cleaner 13 removes residual toner remaining on the intermediate transfer belt 9 after the image transfer. The intermediate transfer unit 10, the primary transfer rollers 11, the secondary transfer roller 12, and the belt cleaner 13 are components of a transfer device 23. Above the secondary transfer roller 12, a fixing device 14 is disposed. The fixing device 14 includes a heating roller 14A and a pressure roller 14B and fixes the toner image having been secondarily transferred onto the sheet S. The fixing device 14 is configured to be detachable from the body 2, that is, replaceable, and is replaced as the fixing function is lowered due to deterioration of each component.

A sheet feeder 15 is disposed in a lower portion of the body 2. The sheet feeder 15 includes a sheet tray 16, a sheet feeding roller 17, and a registration roller pair 18. The sheet feeding roller 17 feeds the sheet S stored in the sheet tray 16 toward the registration roller pair 18. The registration roller pair 18 feeds the sheet S toward the secondary transfer nip, where the secondary transfer roller 12 presses against the intermediate transfer belt 9, at such a timing that the toner image formed on the intermediate transfer belt 9 matches a predetermined position on the sheet S. In an upper portion of the body 2, toner bottles 19Y, 19C, 19M, and 19K containing corresponding color toners to be supplied to the developing devices 6 are disposed.

When the full-color toner image is formed on the intermediate transfer belt 9, in the sheet feeder 15, the sheets S in the sheet tray 16 are separated and fed one by one by the sheet feeding roller 17. The fed sheet S is sent to the secondary transfer nip at a predetermined timing by the registration roller pair 18. The sheet S bearing the full-color toner image transferred from the intermediate transfer belt 9 at the secondary transfer nip is conveyed to the fixing device 14 to fix the transferred image. After the fixing, an ejection roller pair 24 ejects the sheet S onto an output tray 25 on an upper face of the body 2. The ejection roller pair 24 is disposed downstream from the fixing device 14 in a sheet conveyance direction. Similar to the photoconductor drums 4, the belt cleaner 13 cleans the transfer residual toner remaining on the intermediate transfer belt 9. From the toner bottles 19, respective color toners are supplied to the corresponding developing devices 6 via a conveyance passage as necessary.

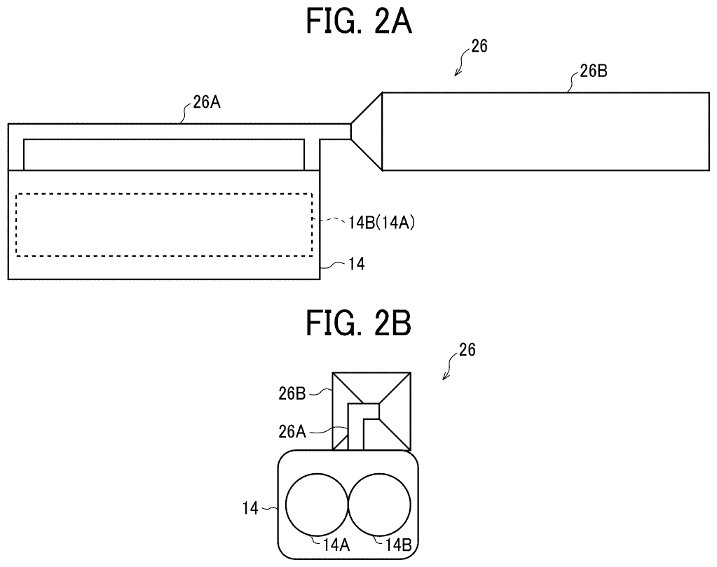

Features of the present disclosure are described below. In FIG. 1, a duct 26 is disposed above the fixing device 14 and coupled to the fixing device 14. The duct 26 takes in air including substances generated from the fixing device 14 during operation of the fixing device 14 and discharges the taken air to the outside of the body 2 in a discharge direction. As illustrated in FIGS. 2A and 2B, the duct 26 includes a connecting portion 26A connected to the fixing device 14 and a duct body 26B.

The connecting portion 26A includes a hollow pipe having a square pipe shape as illustrated in FIGS. 2A and 2B, but the shape of the connecting portion 26A is not limited to this and may be, for example, a round pipe shape. The connecting portion 26A is connected to the duct body 26B and both end portions of the fixing device 14 in the longitudinal direction. The air in the fixing device 14 flows to the duct body 26B through the connecting portion 26A.

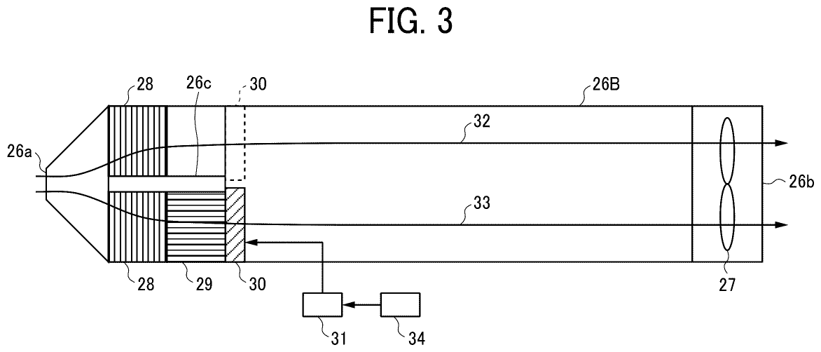

As illustrated in FIG. 3, the duct body 26B has a rectangular cross section and includes an intake 26a and a vent 26b that are disposed at both ends of the duct body 26B in the longitudinal direction of the duct body 26B. The intake 26a is connected to the connecting portion 26A and takes in air. The vent 26b exhausts the taken air. An exhaust fan 27 as an exhauster is disposed close to the vent 26b in the duct body 26B. In other words, the exhaust fan 27 is at a downstream end in the discharge direction of the duct body 26B and is closer to the vent 26b than the intake 26a in the longitudinal direction in the duct body 26B. The exhaust fan 27 operates to take air into the duct body 26B and generate an air flow from the intake 26a to the vent 26b. The exhaust fan 27 is configured to be switchable between at least two stages of high and low power (in other words, large and small numbers of rotations per unit time). In other words, the exhaust fan 27 is configured to operate at least a first power and a second power that is larger than the first power.

A partition 26c is disposed close to the intake 26a in the duct body 26B. The partition 26c divides air taken in from the intake 26a into two, upper and lower, in the present embodiment. A first filter 28 is disposed in an upper space partitioned by the partition 26c. The first filter 28 collects substances other than ultrafine particles, which are referred to as first substances, in the taken air. The ultrafine particles are a type of the above-described ultrafine particles (UFP) (particulate matter (PM)) having diameters equal to or smaller than 50 nm among suspended particulate matter (SPM) which floats in the atmosphere. Examples of the first filter 28 include an ozone removal filter to remove ozone generated in the process cartridge 3. The first filter 28 and a second filter 29 are disposed in a lower space partitioned by the partition 26c. The second filter 29 collects substances including ultrafine particles, which are referred to as second substances, in the taken air.

A movable shielding plate 30 is disposed at one of an air outlet in the upper space and an air outlet in the lower space. The movable shielding plate 30 closes one of the upper space and the lower space and communicates the other with a downstream space in the duct body 26B. An exhaust switching device 31 including a motor or a solenoid selectively positions the shielding plate 30 at one of the first position indicated by a solid line in FIG. 3 and the second position indicated by a broken line in FIG. 3. The shielding plate 30 at the first position closes the lower space and communicates the upper space with the downstream space in the duct body 26B. The shielding plate 30 at the second position closes the upper space and communicates the lower space with the downstream space in the duct body 26B. When the shielding plate 30 occupies the first position, the air taken in from the intake 26a by the operation of the exhaust fan 27 passes through the upper space and flows toward the vent 26b via the inside of the duct body 26B. This air flow path is referred to as a first exhaust path 32. The first exhaust path 32 includes the first filter 28 to pass the air from which the first substances are filtered and the second substances are not filtered. When the shielding plate 30 occupies the second position, the air taken in from the intake 26a by the operation of the exhaust fan 27 passes through the lower space and flows toward the vent 26b via the inside of the duct body 26B. This air flow path is referred to as a second exhaust path 33. The second exhaust path 33 includes the first filter 28 and the second filter 29 to pass the air from which both the first substances and the second substances are filtered. The shielding plate 30 and the exhaust switching device 31 function as a switch to switch between the first exhaust path 32 and the second exhaust path 33. A controller 34 as circuitry such as a microcomputer controls the operation of the exhaust switching device 31.

Based on the above-described configuration, the following describes control to change an exhaust path. The exhaust switching device 31 switches the position of the shielding plate 30 to change the exhaust path.

In FIG. 3, the exhaust switching device 31 positions the shielding plate 30 at the first position to flow the air taken in from the intake 26a through the first exhaust path 32, and the air flowing in from the intake 26a passes through the first filter 28 and is discharged from the vent 26b. The exhaust switching device 31 positions the shielding plate 30 at the second position to flow the air taken in from the intake 26a through the second exhaust path 33, and the air flowing in from the intake 26a passes through the first filter 28 and the second filter 29 and is discharged from the vent 26b. The air flowing through the first exhaust path 32 passes through the first filter 28. In contrast, the air flowing through the second exhaust path 33 passes through the first filter 28 and the second filter 29. As a result, the pressure loss of the air flowing through the second exhaust path 33 is larger than that of the air flowing through the first exhaust path 32. Accordingly, the power (in other words, the rotation number per unit time) of the exhaust fan 27 to flow the air taken in from the intake 26a through the second exhaust path 33 is set to be larger than that to flow the air taken in from the intake 26a through the first exhaust path 32, which increases power consumption and noise during operation.

Flowing the air taken in from the intake 26a through the second exhaust path 33 to collect the ultrafine particles increases the pressure loss. To countermeasure the above-described disadvantage, shortening the time for which the air flows through the second exhaust path 33 as much as possible reduces the increase in power consumption and the increase in noise.

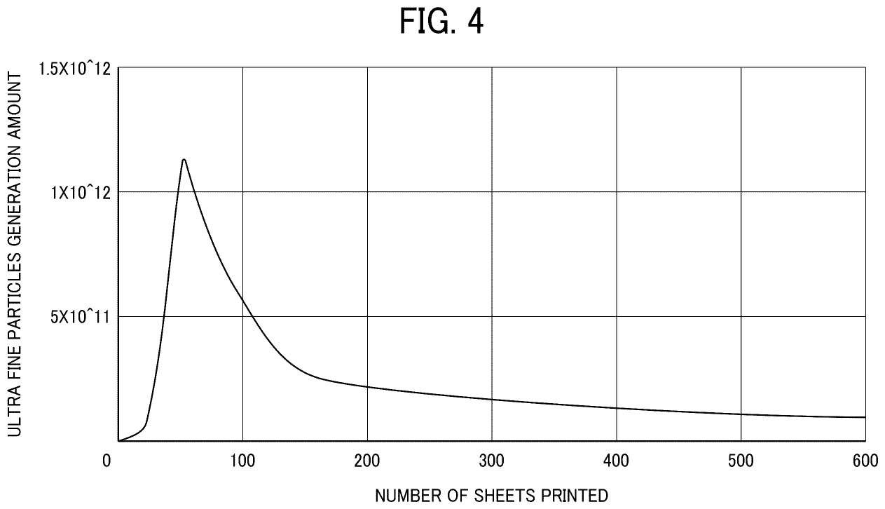

FIG. 4 is a graph illustrating a relation between an amount of ultrafine particles (UFP) generated and a number of sheets on which images are formed when the color copier 1 continuously forms images under a certain image forming condition. The amount of ultrafine particles generated depends on device factors such as oil components for roller lubrication used in the fixing device 14 and supply factors such as wax of the toner. As illustrated in FIG. 4, the amount of ultrafine particles generated is extremely small when the number of sheets on which images are formed under this image forming condition reaches 200, and after that, the change in the amount of ultrafine particles generated is small.

Based on the above, the controller 34 in the present embodiment counts the number of sheets on which images are formed and determines whether the number of sheets on which the images are formed reaches a predetermined number. In response to the number of sheets on which images are formed reaching the predetermined number, the controller 34 operates the exhaust switching device 31. Specifically, since the amount of generated ultrafine particles is large from the start of image formation until the number of sheets on which images are formed reaches the predetermined number of 200, the controller 34 operates the exhaust switching device 31 to position the shielding plate 30 at the second position and sets the air flowing in from the intake 26a to pass through the second exhaust path 33. Thus, the air flowing in from the intake 26a at the initial stage flows through the second exhaust path 33, and the first filter 28 and the second filter 29 collect the ultrafine particles and purify the air. However, since flowing the air through the second exhaust path 33 causes a large pressure loss, the controller 34 increases the power of the exhaust fan 27 to the second power, which increases power consumption and noise.

Subsequently, the controller 34 determines that the number of sheets on which images are formed reaches the predetermined number of 200 and operates the exhaust switching device 31 to displace the shielding plate 30 from the second position to the first position. The flow path of the air flowing in from the intake 26a is switched from the second exhaust path 33 to the first exhaust path 32, and the air containing almost no ultrafine particles is purified by the first filter 28 and discharged from the vent 26b to the outside of the color copier 1. The air does not pass through the second filter 29. Since the pressure loss in the air flowing through the first exhaust path 32 is smaller than that in the air flowing through the second exhaust path 33, the controller 34 controls the power of the exhaust fan 27 to be smaller than that until the number of sheets on which images are formed reaches the predetermined number. In other words, the controller 34 operates the exhaust fan 27 at the first power smaller than the second power in response to the number of sheets on which images are formed reaching the predetermined number. As a result, power consumption and noise generation are significantly reduced.

In addition, the amount of the ultrafine particles generated is related to a power-on time of the color copier 1, that is, the heating time of the fixing device 14, in addition to the number of sheets on which images are formed, and the color copier 1 includes a heating time integrator that integrates the heating time of the fixing device 14. The amount of generated ultrafine particles is large until the heating time of the fixing device 14 reaches a predetermined time and decreases when the heating time exceeds the predetermined time, and the change in the amount of ultrafine particles generated is small. The controller 34 acquires the heating time of the fixing device 14 from the heating time integrator and determines whether the heating time of the fixing device 14 exceeds the predetermined time, for example, 60 seconds. In response to the heating time of the fixing device 14 exceeding the predetermined time, the controller 34 operates the exhaust switching device 31 to displace the shielding plate 30 from the second position to the first position, changes the flow path of the air from the second exhaust path 33 to the first exhaust path 32, and changes the power of the exhaust fan 27 to the first power smaller than the second power.

When the heating time of the fixing device 14 reaches the predetermined time before the number of sheets on which images are formed reaches the predetermined number, the controller 34 in the above-described configuration operates the exhaust switching device 31 to switch the exhaust path of the air from the second exhaust path 33 to the first exhaust path 32 and operates the exhaust fan 27 with the small first power, which can significantly reduce power consumption and noise generation.

In addition, the amount of the ultrafine particles generated is related to replacement of the fixing device 14 in addition to the number of sheets on which images are formed and the heating time, and the color copier 1 includes a replacement detector that detects the replacement of the fixing device 14. An example of the replacement detector is a microswitch disposed in the body 2 which the fixing device 14 is attached to and detached from. When the fixing device 14 (used) is removed from the body 2 and the fixing device 14 (new) is attached to the body 2, the microswitch is turned on after being turned off once. At this time, the controller 34 determines that the fixing device 14 has been replaced. The amount of ultrafine particles generated depends on device factors such as oil components for roller lubrication used in the fixing device 14 as described above. Accordingly, the replacement of the fixing device 14 increases the amount of the ultrafine particles generated.

When the replacement detector detects the replacement of the fixing device 14, the controller 34 determines that the fixing device 14 has been replaced. Subsequently, the controller 34 operates the exhaust switching device 31 to displace the shielding plate 30 from the first position to the second position, changes the flow path of the air from the first exhaust path 32 to the second exhaust path 33, and changes the power of the exhaust fan 27 to a large power as the second power.

When the replacement detector detects the replacement of the fixing device 14, the controller 34 in the above-described configuration operates the exhaust switching device 31 to switch the exhaust path of the air from the first exhaust path 32 to the second exhaust path 33 and operates the exhaust fan 27 with the large power regardless of the heating time of the fixing device 14 and the number of sheets on which images are formed. As a result, the above-described configuration can effectively purify the air containing a large amount of ultrafine particles generated from the replaced fixing device 14. When the controller 34 determines that the fixing device has been replaced, the controller 34 resets the heating time, which has been integrated by the heating time integrator, to zero.

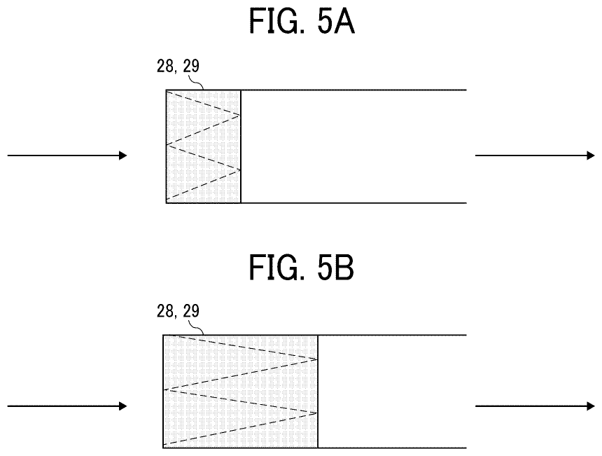

In the above-described configurations, at least one of the first filter 28 and the second filter 29 may be a pleated filter as illustrated in FIGS. 5A and 5B. The pleated filter illustrated in FIG. 5B has a thickness (a length in the air traveling direction (the left-right direction) indicated by the arrows in FIGS. 5A and 5B) larger than that of the pleated filter illustrated in FIG. 5A. Increasing the thickness of the pleated filter increases the surface area of the filter, as illustrated by the dashed line in FIG. 5B, which increases the number of vent holes of the filter. As a result, increasing the thickness of each of the first filter 28 and the second filter 29 can reduce the pressure loss, which enables the output of the exhaust fan 27 to be reduced. Reducing the output of the exhaust fan 27 reduces the power consumption and the generation of noise to be smaller than the above embodiments. In other words, the power of the exhaust fan 27 is set based on the thickness of the pleated filter.

In the above embodiments, the controller 34 operates the exhaust switching device 31 in response to the number of sheets on which images are formed exceeding 200 sheets as the predetermined number of sheets and the heating time of the fixing device 14 exceeding 60 seconds as the predetermined time. However, since the predetermined number of sheets and the predetermined time are changed depending on the image forming condition, the predetermined number of sheets and the predetermined time are not limited to these numerical values. The power of the exhaust fan 27 is switchable between two levels, i.e., the small power and the large power but may be switchable between three or more levels.

In the above-described embodiments, an example of the image forming apparatus applicable to the present disclosure is the color copier 1 forming the color image, but the image forming apparatus applicable to the present disclosure is not limited to this. The present disclosure is also adoptable to a printer, a facsimile machine, and a multifunction peripheral (MFP).

In the above-described embodiments, the sheet S is mentioned as an example of the recording medium on which an image is formed and is not limited the standard paper but also includes thick paper, a postcard, a rolled sheet, an envelope, plain paper, thin paper, coated paper, art paper, tracing paper, an overhead projector transparency (OHP sheet or OHP film), a resin film, and any other sheet-shaped material on which an image can be formed.

Aspects of the present disclosure are, for example, as follows.

### <First Aspect>

In a first aspect, an image forming apparatus has the following features. The image forming apparatus includes a fixing device, a duct, an exhaust fan, a first filter, a second filter, a first exhaust path, a second exhaust path, an exhaust switching device, and a controller. The fixing device heats a toner image on a sheet and fixes the toner image onto the sheet. The duct takes in air including ultrafine particles generated from the fixing device during operation of the fixing device and discharges the air to an outside of the image forming apparatus. The exhaust fan operates to take in the air into the duct and is operable at least a small power and a large power. One of the small power and the large power is selected. The first filter collects substances other than the ultrafine particles in the air. The second filter collects substances including the ultrafine particles in the air. The first exhaust path includes the first filter and passes the air. The second exhaust path includes the first filter and the second filter and passes the air. The exhaust switching device switches an exhaust path of the air to either the first exhaust path or the second exhaust path. The controller controls an operation of the exhaust switching device in accordance with a number of sheets on which images are formed, operates the exhaust switching device to switch the exhaust path of the air from the second exhaust path to the first exhaust path in response to the number of sheets reaching a predetermined number, and operates the exhaust fan at the small power.

### <Second Aspect>

In a second aspect, the image forming apparatus according to the first aspect has the following feature. The image forming apparatus includes a heating time integrator to integrate a heating time of the fixing device. When the heating time integrated reaches a predetermined time before the number of sheets on which the images are formed reaches the predetermined number, the controller operates the exhaust switching device to switch the exhaust path of the air from the second exhaust path to the first exhaust path and operates the exhaust fan at the small power.

### <Third Aspect>

In a third aspect, the image forming apparatus according to the second aspect has the following feature. The fixing device is replaceable. The image forming apparatus includes a replacement detector to detect replacement of the fixing device. When the replacement detector detects the replacement of the fixing device, the controller resets the heating time integrated by the heating time integrator and operates the exhaust switching device to switch the exhaust path of the air from the first exhaust path to the second exhaust path and operates the exhaust fan at the large power.

### <Fourth Aspect>

In a fourth aspect, the image forming apparatus according to any one of the first to third aspects has the following feature. The thicknesses of the first filter and the second filter are increased, and the controller operates the exhaust fan at the small power.

The above-described embodiments are illustrative and do not limit the present disclosure. Thus, numerous additional modifications and variations are possible in light of the above teachings. For example, elements and/or features of the embodiment and variation may be combined with each other and/or substituted for each other within the scope of the present disclosure. For example, the duct body 26B in the above-described embodiments includes the two vertically separated exhaust paths but may include two laterally separated exhaust paths.

The advantages achieved by the embodiments described above are examples and therefore are not limited to those described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a fixing device to heat a toner image on a sheet and fix the toner image onto the sheet; and
a duct coupled to the fixing device to take in air and discharge the air outside the image forming apparatus in a discharge direction, the duct including:
a first filter to collect first substances other than ultrafine particles, generated from the fixing device during a fixing operation of the fixing device, in the air;
a second filter to collect second substances including the ultrafine particles in the air;
a first exhaust path including the first filter to pass the air from which the first substances are filtered and the second substances are not filtered; and
a second exhaust path including the first filter and the second filter to pass the air from which both the first substances and the second substances are filtered;
an exhaust fan at a downstream end in the discharge direction of the duct, to take in the air into the duct; and
a switch to switch between the first exhaust path and the second exhaust path.

2. The image forming apparatus according to claim 1, further comprising circuitry configured to:
operate the exhaust fan at a first power or a second power larger than the first power;
count a number of sheets each having the toner image;
determine whether the number of sheets reaches a predetermined number;
operate the switch to switch to the second exhaust path; and
operate the exhaust fan at the second power,
when the number of sheets does not reach the predetermined number; and
operate the switch to switch from the second path to the first exhaust path; and
operate the exhaust fan at the first power,
when the number of sheets reaches the predetermined number.

3. The image forming apparatus according to claim 2,
wherein the circuitry includes a heating time integrator to integrate a heating time of the fixing device, and
the circuitry is further configured to:
operate the switch from the second exhaust path to the first exhaust path when the heating time integrated by the heating time integrator reaches a predetermined time before the number of sheets reaches the predetermined number; and
operate the exhaust fan at the first power.

4. The image forming apparatus according to claim 3, further comprising
a replacement detector to detect a replacement of the fixing device,
wherein the circuitry is configured to, in response to a detection of the replacement of the fixing device by the replacement detector,
reset the heating time integrated by the heating time integrator;
operate the switch to switch from the first exhaust path to the second exhaust path; and
operate the exhaust fan at the second power.

5. The image forming apparatus according to claim 1,
wherein the circuitry is further configured to reduce a power set for operating the exhaust fan with an increase in a thickness of at least one of the first filter or the second filter.

6. The image forming apparatus according to claim 1,
wherein the duct includes a duct body having a rectangular cross section, and the duct body including:
an intake at one end of the duct body, in a longitudinal direction of the duct body 26B, to take in the air; and
a vent at another end of the duct body in the longitudinal direction to exhaust the air taken from the intake, and
the exhaust fan is closer to the vent than the intake in the longitudinal direction in the duct body.
